(19) United States
(12) Patent Application Publication
(10) Pub. No.: US 2023/0114692 A1
(43) Pub. Date: Apr. 13, 2023

(54) WIRELESS COMMUNICATION SYSTEM, WIRELESS CONTROL METHOD, AND WIRELESS BASE STATION APPARATUS

(71) Applicant: NIPPON TELEGRAPH AND TELEPHONE CORPORATION, Tokyo (JP)

(72) Inventors: Masashi IWABUCHI, Musashino-shi, Tokyo (JP); Tomoaki OGAWA, Musashino-shi, Tokyo (JP); Tomoki MURAKAMI, Musashino-shi, Tokyo (JP)

(73) Assignee: NIPPON TELEGRAPH AND TELEPHONE CORPORATION, Tokyo (JP)

(21) Appl. No.: 17/911,723

(22) PCT Filed: Mar. 18, 2020
(86) PCT No.: PCT/JP2020/011947

§ 371 Date: Sep. 15, 2022

(51) Int. Cl. H04L 1/00; H04L 27/26; H04W 16/28

(52) U.S. Cl. CPC H04L 1/0007; H04L 27/2605; H04W 16/28; H04W 88/08

(57) ABSTRACT

A wireless communication system according to an embodiment includes: a wireless base station device configured to perform wireless communication of an orthogonal frequency division multiplexing (OFDM) method; a plurality of dynamic control relay devices for which a reradiation direction of incoming waves is dynamically controllable; and a wireless terminal device configured to perform wireless communication with the wireless base station device. The wireless base station device performs wireless communication with the wireless terminal device using a plurality of propagation paths that go through or do not go through the dynamic control relay devices, and a CP control unit provided in the wireless base station device changes the cyclic prefix length based on whether or not a propagation route from the wireless base station device to the wireless terminal device uses any dynamic control relay device.

### TECHNICAL FIELD

Embodiments of the present invention relate to a wireless communication system, a wireless control method, and a wireless base station device.

### BACKGROUND ART

To realize high speed and large capacity wireless access, using a high frequency band that can ensure a broad bandwidth draws attention. For example, the 5th generation mobile communication system uses a 28 GHz band to realize high speed and large capacity wireless access, and the IEEE 802.11ad (millimeter-wave wireless LAN system), which is a wireless LAN (Local Area Network) standard, uses a 60 GHz band to realize the same.

In a high frequency band, radio waves are significantly attenuated compared to in a frequency band, and have radio properties of being less likely to be diffracted. Therefore, a high frequency band has problems in short transmission distances and significant deterioration of the reception quality due to shielding.

In order to compensate the radio wave attenuation, beamforming is advantageous that uses a multielement antenna in a transmitter station and a receiver station. By compensating the radio wave attenuation based on a beamforming gain, it is possible to increase the transmission distance. In this beamforming, radio waves from a specific direction are strongly transmitted and received in both the transmitter station and the receiver station, and thus one high-power propagation path is mainly received by the receiver station. As a result, the number of spatial multiplexing is kept as 1 (or 2 in the case of polarized multiplexing), and it is also difficult to achieve the space diversity effect by receiving the same signal.

On the other hand, to improve the deterioration of the reception quality caused by shielding or non-line-of-sight, there is a method in which multiple transmission points are installed. For example, by installing many transmission antennas at suitable intervals, it is possible to reduce the range of shielding or non-line-of-sight. It is also possible to solve the above-described problems in beamforming. However, installing many transmission antennas causes problems that the network cost increases and the installation place becomes insufficient.

In view of providing many transmission points, it is also advantageous to use reflectors, repeaters, and the like that are less expensive and have a smaller installation scale and restrictions. Conventionally, it was difficult to perform dynamic control on these devices. However, in recent years, a reflector that uses a metasurface to dynamically control a reflection direction, a repeater that can perform beamforming, and the like have been successfully developed, and thus it is possible to realize a method for achieving spatial multiplexing and a space diversity gain while using these devices to reduce a range of shielding or non-line-of-sight (NPL 1).

### CITATION LIST

### Non Patent Literature

[NPL 1] Yuichiro Sugihara, Kei Sakaguchi, “Review of Cellular Network using mmWave Massive Relay MIMO”, the 2019 IEICE Society Conference, B-5-54

### SUMMARY OF THE INVENTION

### Technical Problem

Even when, as described above, multiple reflectors or repeaters (dynamic control relay devices) that can be dynamically controlled are installed, and the plurality of dynamic control relay devices relay a signal from a transmitter station so as to perform beamforming between the transmitter station and a receiver station, it is possible to form a plurality of different propagation routes, that is, propagation paths. By performing transmission and reception signal processing while recognizing the states of the propagation paths, the transmitter station and the receiver station can perform spatial multiplexing of the spatial multiplexing number of 3 or more, select a propagation path, or obtain a space diversity gain by combining and receiving all of the propagation paths.

Meanwhile, in the 5th generation mobile communication system or the millimeter-wave wireless LAN system that uses a high frequency band, an Orthogonal Frequency Division Multiplexing (OFDM) method is used. In the OFDM method, as a countermeasure for delay waves, a guard interval called a Cyclic Prefix (CP) is added to eliminate an OFDM inter-symbol interference caused by delay waves. With respect to the length of a CP, a suitable CP length is defined based on the system standard or the like, taking into consideration a scenario conceivable by the system and property deterioration caused by overhead due to CP insertion. For example, in the 5th generation mobile communication system, it is conceivable to insert a CP length that is about 7% of the OFDM symbol length.

Also, if delay waves that exceed a CP length are received, there is a problem that OFDM inter-symbol interference cannot be completely eliminated, and the communication quality will be deteriorated. When multiple propagation paths are to be formed by the above-described dynamic control relay devices, it is conceivable that propagation paths that have a larger propagation delay than in a normal case may be generated. For example, a propagation path going through a plurality of dynamic control relay devices has a larger inter-path delay than a propagation path that leads directly from a transmitter station to a receiver station. Also, if repeaters are used as the dynamic control relay devices, processing delays caused by amplification processing within the repeaters will be added. When a plurality of propagation paths are combined and received, there is a high likelihood that a delay propagation path that exceeds the CP length is included, and delay waves having relatively large electric power may be received due to phase control based on a metasurface, and amplification processing and beamforming control of the repeaters.

Specifically, a high frequency band defined in the 5th generation mobile communication system uses a signal with a widened OFDM subcarrier spacing, taking into consideration an influence of phase noise and the like. On the assumption that the OFDM signal bandwidth is constant, when the OFDM subcarrier spacing is widened (that is to say, the number of OFDM subcarriers is reduced), the OFDM subcarrier width is increased, and a primary modulation signal can be transmitted in a broader frequency band. Thus, the symbol length of an OFDM subcarrier signal is reduced. Because an OFDM signal is a signal obtained by superimposing OFDM subcarrier signals, if the symbol lengths of the OFDM subcarrier signals are reduced, the OFDM symbol length will also be reduced consequently.

Accordingly, the OFDM symbol length is reduced in proportion with the OFDM subcarrier spacing. In the 5th generation mobile communication system, the ratio of the CP length to the OFDM symbol length is basically set to be constant for all OFDM subcarrier spacing options, taking into consideration the overhead due to the CP length. Therefore, if multiple propagation paths are generated by dynamic control relay devices 4 in a high frequency band, the properties may rather be deteriorated by the influence of delay waves that exceed the CP length.

Note that there is also a case where an extended CP length, which is greater than a normal CP length, is defined taking into consideration long delay waves. Using an extended CP length can solve the above-described problems, but it is not preferable in view of the overhead to always use the extended CP length.

Thus, the embodiments of the present invention provide: a wireless communication system that performs transmission and reception using multiple propagation paths that are generated with a plurality of dynamic control relay devices, in which control of the propagation paths and control of a CP length are performed in a cooperated manner; a wireless control method; and a wireless base station device.

### Means for Solving the Problem

In order to solve the above-described problems, a wireless communication system according to an aspect of the present invention includes: a wireless base station device that includes a control unit for determining a cyclic prefix length, and is configured to perform wireless communication of an orthogonal frequency division multiplexing (OFDM) method; a plurality of dynamic control relay devices for which a reradiation direction of incoming waves is dynamically controllable by the wireless base station device; and a wireless terminal device configured to perform wireless communication with the wireless base station device using a plurality of propagation paths that go through or do not go through the dynamic control relay devices, wherein if the wireless communication is performed between the wireless base station device and the wireless terminal device using the plurality of propagation paths going through the dynamic control relay devices, the control unit determines a second cyclic prefix length that is greater than a preliminarily allocated first cyclic prefix length if a predetermined setting condition that relates to wireless communication is satisfied.

### Effects of the Invention

According to the wireless communication system, the wireless control method, and the wireless base station device of the present embodiments, in the wireless communication system that performs transmission and reception using multiple propagation paths that are generated with a plurality of dynamic control relay devices, a propagation path to be used in the transmission and reception is determined by a wireless base station, and a CP length that corresponds to the propagation path is set. This makes it possible to prevent occurrence of OFDM inter-symbol interference, and reduce a deterioration in the wireless communication quality.

### BRIEF DESCRIPTION OF DRAWINGS

FIG. 1 is a schematic diagram illustrating an example of a configuration of a wireless communication system according to a first embodiment.

FIG. 2 is a block diagram illustrating examples of hardware configurations of a wireless base station device according to the first embodiment.

FIG. 3 is a schematic diagram illustrating an example of a configuration of a computer that functions as the wireless base station device.

FIG. 4 is a block diagram illustrating an example of a hardware configuration of a wireless terminal device according to the first embodiment.

FIG. 5 is a flowchart illustrating an example of a CP length determination processing operation performed by a CP control unit of the wireless base station device according to the first embodiment.

FIG. 6 is a flowchart illustrating an example of a CP length determination processing operation performed by the CP control unit of the wireless base station device according to a second embodiment.

FIG. 7 is a flowchart illustrating an example of a CP length determination processing operation performed by the CP control unit of the wireless base station device according to a third embodiment.

FIG. 8 is a flowchart illustrating an example of a CP length determination processing operation performed by the CP control unit of the wireless base station device according to a fourth embodiment.

FIG. 9 is a flowchart illustrating an example of a CP length determination processing operation performed by the CP control unit of the wireless base station device according to a fifth embodiment.

FIG. 10 is a flowchart illustrating an example of a CP length determination processing operation performed by the CP control unit of the wireless base station device according to a sixth embodiment.

### DESCRIPTION OF EMBODIMENTS

Hereinafter, embodiments of the present invention will be described in detail with reference to the drawings.

### First Embodiment

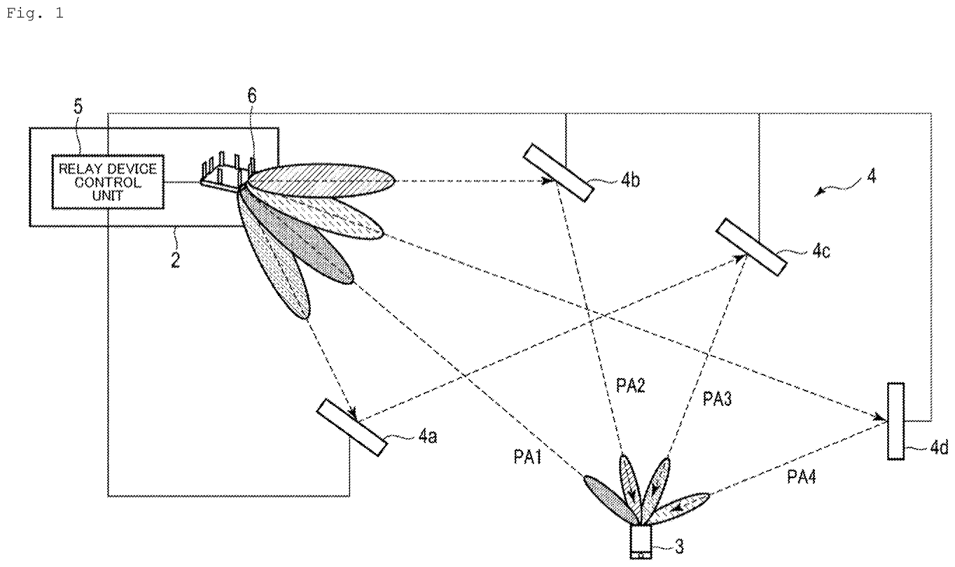

FIG. 1 is a schematic diagram illustrating an example of a configuration of a wireless communication system 1 according to a first embodiment. As the wireless communication system 1 of the present embodiment, an example is described in which a wireless base station device 2 is set as a transmitter station, and a wireless terminal device 3 is set as a receiver station. The present invention also includes a case where after the start of communication, the settings of the transmitter station and the receiver station are inverted, that is, the wireless base station device 2 is switched to a receiver station, and the wireless terminal device 3 is switched to a transmitter station.

In the wireless communication system 1 shown in FIG. 1, a plurality of dynamic control relay devices 4 (4a, 4b, 4c, and 4d) are installed within wireless channels between the transmitter station and the receiver station. The number of installed dynamic control relay devices 4 can be suitably set according to the size of the communication area and an environment for radio waves (such as an environment with a lot of shielding objects). Each of the dynamic control relay devices 4 is a repeater or a reflector, for example. A dynamic control relay devices 4 that is constituted by a repeater is defined as an active device, and a dynamic control relay devices 4 that is constituted by a reflector is defined as a passive device. These dynamic control relay devices 4 can reradiate incoming waves in any direction by mechanically moving or rotating, or electrically controlling their phases or amplitudes.

As shown in FIG. 1, in the wireless communication system 1, a propagation path PA1 leading from the wireless base station device 2 to the wireless terminal device 3 without the intermediary of any dynamic control relay device 4, and three propagation paths PA2, PA3, and PA4 that go through any dynamic control relay device 4 are generated. These propagation paths may include a propagation path like the propagation path PA3 that is generated by the intermediary of the plurality of dynamic control relay devices 4a and 4c.

The wireless base station device 2 includes a relay device control unit 5 and a wireless communicator 6. Each of the dynamic control relay devices 4 is connected to the relay device control unit 5 of the wireless base station device 2 by wired communication or wireless communication, so that the reradiation direction is controlled. The relay device control unit 5 has functions of determining information relating to at least one of the dynamic control relay devices 4 that is to be used in wireless transmission and to the reradiation direction thereof, and notifying the dynamic control relay device 4 of the information. The relay device control unit 5 also has a function of collecting the state of the dynamic control relay device 4, and information available by the dynamic control relay device 4.

Here, information available by the dynamic control relay device 4 means, for example, information obtained by a dynamic control relay device 4 having a sensing function, using its sensing function. Also, examples of the information obtained using the sensing function include position information obtained by a GPS (Global Positioning System) sensor or the like, and an installation angle of the dynamic control relay device 4 obtained by a gyrosensor or the like.

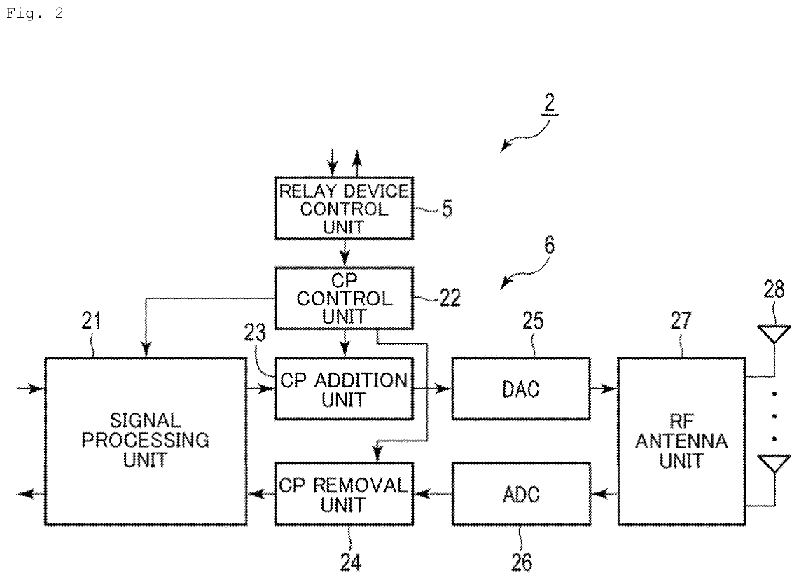

FIG. 2 is a block diagram illustrating an example of a hardware configuration of the wireless base station device 2 according to the first embodiment. As described above, the wireless base station device 2 includes the relay device control unit 5 and the wireless communicator 6.

As described above, the relay device control unit 5 determines information relating to at least one dynamic control relay device 4 to be used in wireless transmission and to a reradiation direction thereof, notifies the dynamic control relay device 4 of the information, and collects the state of the dynamic control relay device 4 and information available by the dynamic control relay device 4. The determination operation, the notification operation, and the collection operation of the relay device control unit 5 may be performed at any timing (or any time span). For example, when the reflection/reradiation direction of a dynamic control relay device 4 is to be oriented to the wireless terminal device 3 in a pinpoint manner, the relay device control unit 5 determines information relating to at least one dynamic control relay device 4 to be used in wireless transmission and a reradiation direction, at a timing at which the wireless base station device 2 performs beam control.

As a specific example, when beam searching is executed using a synchronization signal, the timing at which the above-described determination is performed matches a timing at which after transmission of the synchronization signal, the searching is complete for combinations of all beams and all reflection/reradiation directions. At this time, the relay device control unit 5 determines information relating to at least one dynamic control relay device 4 to be used in wireless transmission and a reradiation direction, so that the beams, the dynamic control relay device 4, and the reflection/reradiation direction that have the best reception quality are selected. Also, the relay device control unit 5 may transmit a synchronization signal to only search all beams. At this time, the relay device control unit 5 determines at least one dynamic control relay device 4 and a reflection/reradiation direction using, for example, a positioning result of the wireless terminal device 3, and determines beams by beam searching. The positioning result may be obtained by positioning performed by the wireless base station device 2, or may be obtained by feeding back a result of positioning performed by the wireless terminal device 3. There is no particular regulation for the positioning method.

Also, the reflection/reradiation direction may be controlled so as to be oriented to the wireless terminal device 3, or may be oriented to an area in which the wireless terminal device 3 is present. If, for example, a metamaterial reflector is used as a dynamic control relay device 4, radio waves can be reflected in various directions, and if a repeater capable of performing beamforming is used as a dynamic control relay device 4, it is possible to perform beam control and reradiate radio waves in a wide beam width. In this case, the reflection/reradiation direction of the dynamic control relay device 4 is not necessarily controlled according to the movement of the wireless terminal device 3, and thus the relay device control unit 5 may suitably determine the above-described information relating to at least one dynamic control relay device 4 to be used in wireless transmission and a reradiation direction, within a range from several milliseconds to several seconds, or may determine the above-described information in units of day. At this time, the information on which the determination of the relay device control unit 5 is based may be the positioning result of the wireless terminal device 3 as described above, or may be a distribution of the wireless terminal device 3 obtained by previous positioning results. Alternatively, as the basis of the determination, the relay device control unit 5 may use a result obtained by capturing an image of the actual place using a camera and analyzing the image, or may use radio wave propagation information obtained by simulation. Furthermore, it is also possible to use statistical information relating to reception power, communication quality, and traffic obtained when the wireless base station device 2 communicates with the wireless terminal device 3.

Also, on the assumption that information on the arrangement of the dynamic control relay devices 4 is known, if beams and reflection/reradiation directions are determined, it is possible to estimate routes through which radio waves come from the wireless base station device 2 to the wireless terminal device 3. Accordingly, based on this result, the relay device control unit 5 can determine at least one dynamic control relay device 4 to be used.

The wireless communicator 6 of the present embodiment at least includes a signal processing unit 21, a CP control unit 22, a CP addition unit 23, a CP removal unit 24, a Digital to Analog converter (DAC) 25, an Analog to Digital converter (ADC) 26, an RF antenna unit 27, and a plurality of antennas 28.

The CP control unit 22 determines the length (CP length) of a Cyclic Prefix (CP) to be added to a transmission signal, based on the information relating to the dynamic control relay device 4 to be used in wireless transmission that was determined by the relay device control unit 5. The CP control unit 22 determines, in accordance with a later-described CP length setting condition, to change a later-described normal CP length to an extended CP length or the greatest CP length, which are greater than the normal CP length, if the condition is satisfied. Also, the CP control unit 22 controls the CP addition unit 23 to add a CP to a wireless signal to be transmitted, and controls the CP removal unit 24 to remove a CP added to a reception signal. This CP length setting condition is a setting condition relating to wireless communication, and is changeable. The CP length setting condition may be selected from among a plurality of preset CP length setting conditions. Furthermore, it is also possible to set a plurality of CP length setting conditions at the same time, depending on the content of the conditions.

As described above, the CP length is defined based on the system standard or the like, taking into consideration the scenario (such as, for example, the communication route and the communication distance) conceivable by the wireless communication system, and property deterioration by the overhead due to CP insertion. In the following description, a CP length refers to a preset length defined based on the above-described standard or the like, and is set based on a conceivable communication distance or the like, and a CP length that is used always or normally is referred to as a normal CP length (first cyclic prefix length). Accordingly, various CP lengths or the same CP length are/is allocated to the dynamic control relay devices 4 depending on the installation states including a geography in which the respective dynamic control relay devices 4 are provided or the distances from the wireless communicator 6. Here, when the distance is not greater than the conceivable communication distance and depending on the communication state, favorable wireless communication may be possible, even using a dynamic control relay device 4 on the midway of a propagation path, and even using a CP of the preliminarily allocated CP length (normal CP length).

Also, the CP control unit 22 stores in advance information (CP length information) relating to CP lengths preliminarily allocated to all of the dynamic control relay devices 4. The preliminary allocation of CP lengths may be determined when the dynamic control relay devices 4 are installed. Alternatively, if a dynamic control relay device 4 includes a GPS sensor or a gyrosensor, the dynamic control relay device 4 may notify the relay device control unit 5 of the wireless base station device 2 of positional information obtained by the GPS sensor of the relay device or installation angle information obtained by the gyrosensor in a wired or wireless manner on a regular basis, and the relay device control unit 5 may determine an appropriate CP length and may perform update thereto.

Furthermore, the CP control unit 22 controls the signal processing unit 21 to process the determined CP length information into a wireless signal, and notifies the wireless terminal device 3, which serves as a communication target, of the determined CP length information via the RF antenna unit 27. This notification may be made using a control channel of the wireless communication system 1 or another channel.

The CP addition unit 23 adds a CP based on the CP length determined by the CP control unit 22 to a wireless signal generated by the signal processing unit 21. The wireless signal to which the CP is added is output to the DAC 25. Note that a filtering unit may be provided on the downstream of the CP addition unit 23.

The CP removal unit 24 removes a CP from a wireless signal received via the RF antenna unit 27 and the ADC 26. The wireless signal from which the CP was removed is output to the signal processing unit 21. Note that a filtering unit may be provided on the upstream of the CP removal unit 24.

The DAC 25 has a digital/analog conversion function and converts a digital wireless signal to which a CP was added by the CP addition unit 23 into an analog signal. The converted analog wireless signal is output to the RF antenna unit 27. The ADC 26 has an analog/digital conversion function and converts an analog wireless signal received via the RF antenna unit 27 into a digital signal. The converted digital wireless signal is output to the CP removal unit 24.

As transmission processing, the RF antenna unit 27 up-converts, in an RF unit, a wireless signal into a signal of a system band frequency. Then, the signal whose power was amplified by a power amplifier is radiated via the antenna 28. In the reception processing of the RF antenna unit 27, a signal received by the antenna 28 is amplified by a low noise amplifier, and then is down-converted. The RF antenna unit 27 may also include a plurality of RF units and the plurality of antennas 28. In the transmission and reception processing of the RF antenna unit 27, a variable phase shifter and a variable gain controller may be used to perform analog beamforming.

The signal processing unit 21 performs processing for generating a wireless signal to be transmitted, and processing for decoding a received wireless signal. The signal processing unit 21 generates and decodes all signals required in the corresponding wireless communication system 1. Also, the signal processing unit 21 generates, based on the CP length information determined by the CP control unit 22, a wireless signal to be used to notify the wireless terminal device 3 of this CP length information.

At least portions of the hardware configuration that are associated with wireless transmission performed by the relay device control unit 5 and the wireless communicator 6 that constitute the wireless base station device 2 can be realized by IC circuits such as ASICs (Application Specific Integrated Circuit) or FPGAs (Field Programmable Gate Array). For example, the relay device control unit 5 may be formed of one ASIC, and the CP control unit 22, the CP addition unit 23, the CP removal unit 24, and the signal processing unit 21 may be formed of one ASIC. The DAC 25 and the ADC 26 may be formed of one IC chip, and the RF antenna unit 27 may also be formed of one IC chip. Also, portions of the relay device control unit 5 and the wireless communicator 6 that process digital signals may be replaced by a DSP (Digital Signal Processor), and this function may be realized by software provided inside the DSP, or by a computer and a program.

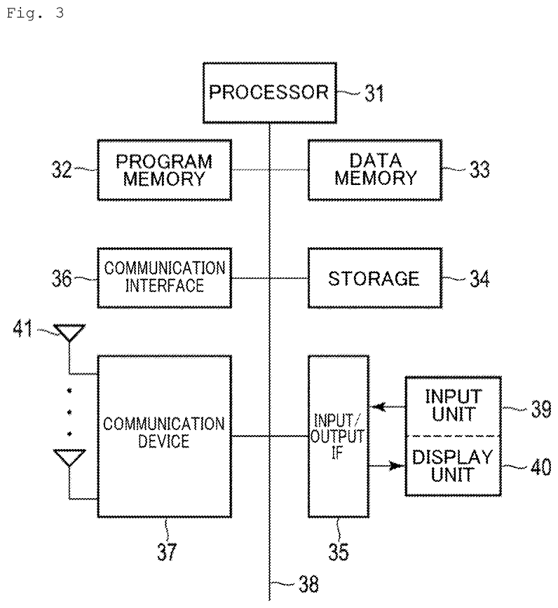

FIG. 3 is a schematic diagram illustrating an example of a configuration of a computer that functions as the wireless base station device 2. As shown in FIG. 3, the wireless base station device 2 is constituted by a computer device, and includes a processor 31 such as a CPU. Also, in the wireless base station device 2, a program memory 32, a data memory 33, a storage 34, an input/output interface (denoted as an input/output IF in FIG. 3) 35, a communication interface 36, and a communication device 37 are connected to the processor 31 via a bus 38.

The program memory 32 serves as a non-transitory and tangible computer-readable storage medium, and is realized by a combination of a freely writable and readable nonvolatile memory such as a flash memory, and a nonvolatile memory such as a ROM (Read Only Memory). In this program memory 32, programs are stored that are required for the processor 31 to execute various types of control processing.

The data memory 33 serves as a tangible computer-readable storage medium, and is realized by a combination of the above-described nonvolatile memory and a volatile memory such as a RAM (Random Access Memory). This data memory 33 is used to store various types of data acquired and generated during the execution of various types of processing.

The storage 34 serves as a non-transitory and tangible computer-readable storage medium, and includes a large-capacity storage medium that uses a freely writable and readable nonvolatile memory such as HDD (Hard Disk Drive) or SSD (Solid State Drive), for example. In this storage 34, various types of programs and data are stored that are required for the processor 31 to execute various types of control processing. For example, a communication control program is stored that is required for the processor 31 serving as the wireless base station device 2 according to the first embodiment to execute control processing. The programs stored in the storage 34 are read into the data memory 33 and are executed by the processor 31 as needed. The communication control program can cause, for example, the processor 31 to function as the relay device control unit 5, the signal processing unit 21, the CP control unit 22, the CP addition unit 23, and the CP removal unit 24 that are shown in FIG. 2. Note that the communication control program may also be stored in the program memory 32, instead of the storage 34.

An input unit 39 and a display unit 40 are connected to the input/output interface 35. The input unit 39 and the display unit 40 may employ a so-called tablet-type input/display device in which a capacitive-type or pressure-type input detection sheet is arranged on a display screen of a liquid crystal or electro luminescence display device, for example. Also, the input unit 39 and the display unit 40 may also be constituted by independent devices. The input/output interface 35 inputs operation information input from the above-described input unit 39 to the processor 31, and causes the display unit 40 to display information for display generated by the processor 31. Note that the computer serving as the wireless base station device 2 does not necessarily include the input/output interface 35, the input unit 39, and the display unit 40. The operation information given to the processor 31 and the information for display given from the processor 31 are transmitted and received by the communication interface 36 via a not-shown network, and can be input from an input device connected to the network or can be displayed on the display device.

The communication interface 36 can include at least one wired or wireless communication module. The communication interface 36 receives data addressed to a user of the wireless terminal device 3 or transmits data from a user to the destination thereof, via a not-shown network.

The communication device 37 can include the DAC 25, the ADC 26, and the RF antenna unit 27 that are shown in FIG. 2. The communication device 37 may also serve as the RF antenna unit 27, and the DAC 25 and the ADC 26 may be arranged between the communication device 37 and the bus 38. An antenna 41 that corresponds to the antenna 28 shown in FIG. 2 is connected to the communication device 37.

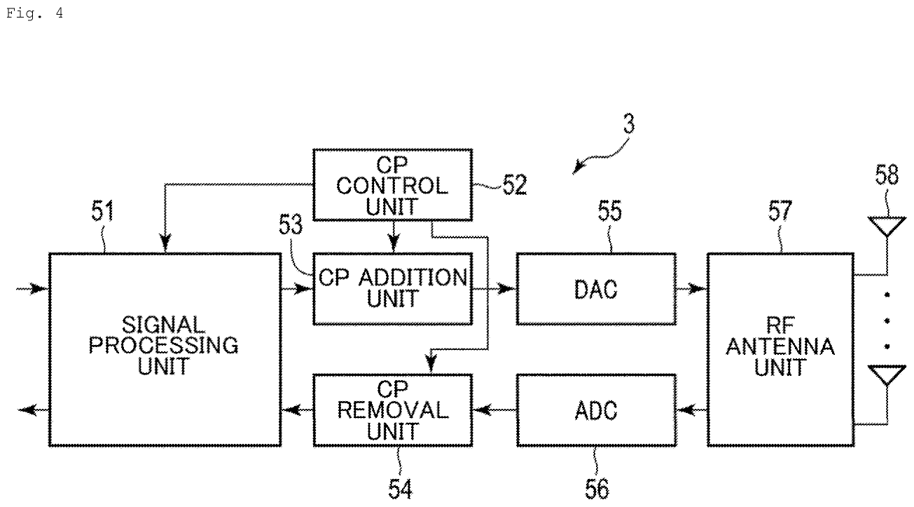

The following will describe a wireless terminal device used in the wireless communication system 1 of the present embodiment. FIG. 4 is a block diagram illustrating an example of a hardware configuration of the wireless terminal device 3 according to the first embodiment.

This wireless terminal device 3 includes a signal processing unit 51, a CP control unit 52, a CP addition unit 53, a CP removal unit 54, a digital/analog converter (DAC) 55, an analog/digital converter (ADC) 56, an RF antenna unit 57, and a plurality of antennas 58.

The CP control unit 52 determines a CP length to be added to the CP addition unit 53 and a CP length to be removed from the CP removal unit 54, based on CP length information that was given via a wireless signal from the wireless base station device 2 and was obtained through processing of the signal processing unit 51 of the wireless terminal device 3, and notifies the CP addition unit 53, the CP removal unit 54, and the signal processing unit 51 of the CP lengths.

The CP addition unit 53 adds a CP based on the CP length determined by the CP control unit 52 to a wireless signal generated by the signal processing unit 51. The wireless signal to which the CP is added is output to the DAC 55. Note that a filtering unit may be provided on the downstream of the CP addition unit 53.

The CP removal unit 54 removes a CP from a wireless signal received via the RF antenna unit 57 and the ADC 56. The wireless signal from which the CP was removed is output to the signal processing unit 51. Note that a filtering unit may be provided on the upstream of the CP removal unit 54.

The DAC 55 has a digital/analog conversion function and converts a digital wireless signal to which a CP was added by the CP addition unit 53 into an analog signal. The converted analog wireless signal is output to the RF antenna unit 57.

The ADC 56 has analog/digital conversion function and converts an analog wireless signal received via the RF antenna unit 57 into a digital signal. The converted digital wireless signal is output to the CP removal unit 54.

The RF antenna unit 57 up-converts, in an RF unit, a wireless signal into a signal of the system band frequency. Then, the signal whose power was amplified by a power amplifier is radiated via the antenna 58. In the reception processing of the RF antenna unit 57, a signal received by the antenna 58 is amplified by a low noise amplifier, and then is down-converted. The RF antenna unit 57 may also include a plurality of RF units and the plurality of antennas 58. In the transmission and reception processing of the RF antenna unit 57, a variable phase shifter and a variable gain controller may be used to perform analog beamforming.

The signal processing unit 51 performs processing for generating a wireless signal to be transmitted, and processing for decoding a received wireless signal. The signal processing unit 51 generates and decodes all signals required in the corresponding wireless communication system 1. Also, the signal processing unit 51 decodes the CP length information given from the wireless base station device 2, and notifies the CP control unit 52 of the obtained CP length information.

At least portions of the hardware configuration that are associated with wireless transmission performed by the wireless terminal device 3 can be realized by IC circuits such as ASICs or FPGAs. For example, the CP control unit 52, the CP addition unit 53, the CP removal unit 54, and the signal processing unit 51 may be formed of one ASIC. The DAC 55 and the ADC 56 may be formed of one IC chip, and the RF antenna unit 57 may also be formed of one IC chip. Also, a digital single processing portion of the hardware configurations that is associated with wireless transmission may be replaced by a DSP, and this function may be realized by software provided inside the DSP, or by a computer and a program.

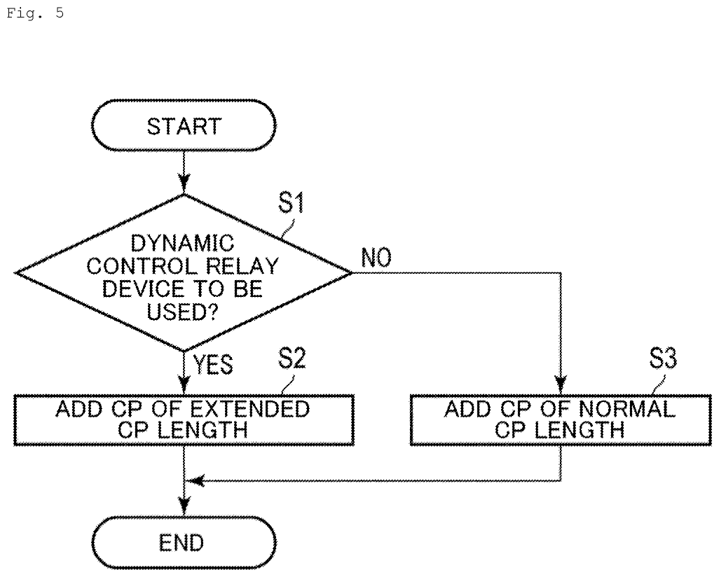

The following will describe CP length determination processing performed by the CP control unit 22 of the wireless base station device 2 according to the first embodiment. FIG. 5 is a flowchart illustrating an example of a CP length determination processing operation performed by the CP control unit 22 of the wireless base station device 2 according to the first embodiment. The CP control unit 22 stores a CP length setting condition (first CP length setting condition) for determining a CP length based on whether or not the propagation paths go through any dynamic control relay device 4. The CP control unit 22 allocates a normal CP, or a CP of the greatest CP length that is greater than the normal CP to a wireless signal, based on whether or not the propagation paths go through any dynamic control relay device 4. If the wireless base station device 2 is constituted by a computer, the processor 31 can execute the processing operation in accordance with this flowchart by executing the communication control program, and can function as the CP control unit 22.

The CP control unit 22 determines whether or not the relay device control unit 5 has given a notification of determination to perform wireless transmission from the wireless base station device 2 to the wireless terminal device 3 of a target user using any dynamic control relay device 4 (step S1). The notification given from the relay device control unit 5 may be a notification indicating whether or not any dynamic control relay device 4 is to be used.

If it is determined that the relay device control unit 5 has given a notification of determination to perform wireless transmission from the wireless base station device 2 using any dynamic control relay device 4 (YES, in step S1), the CP control unit 22 determines to use an extended CP length (second cyclic prefix length) that is greater than the normally used normal CP length. The CP addition unit 22 controls the CP addition unit 23 to add the CP of the extended CP length to a wireless signal generated by the signal processing unit 51 (step S2), and ends the series of CP adding processing.

On the other hand, if it is determined that the relay device control unit 5 has not given a notification of determination to perform wireless transmission from the wireless base station device 2 to the wireless terminal device 3 using any dynamic control relay device 4 (NO, in step S1), the CP control unit 22 determines to use the normal CP length. The CP addition unit 22 controls the CP addition unit 23 to add the CP of the normal CP length to the wireless signal generated by the signal processing unit 51 (step S3), and ends the series of CP adding processing.

With this CP length determination operation performed when any dynamic control relay device 4 is used, it is possible to reduce the influence of delay waves caused by using the dynamic control relay device 4 in this wireless communication system 1. Note that a CP length determination processing operation that is performed by the CP control unit 52 of the wireless terminal device 3 after the start of communication is the same as this operation, except that the determination as to whether or not any dynamic control relay device 4 is to be used is made based on a notification based on settings input by a user, instead of a notification from the relay device control unit 5.

As described above, according to the first embodiment, the wireless communication system 1 is provided that includes the wireless base station device 2 and the plurality of dynamic control relay devices 4, which are relay devices for which a reradiation direction of incoming waves can be dynamically controlled, and in which the wireless base station device 2 performs wireless communication of an OFDM method with the wireless terminal device 3 using a plurality of propagation paths via the dynamic control relay devices 4. In the wireless communication system 1, a CP control unit 22 provided within the wireless base station device 2 changes the CP length based on whether or not any dynamic control relay device 4 is to be used, in accordance with a preset CP length setting condition. That is to say, if the CP length setting condition (first CP length setting condition) is set such that when wireless communication is performed using a plurality of propagation paths via the dynamic control relay devices 4, the CP of the extended CP length, which is greater than the normal CP length, is added to a wireless signal, the CP control unit 22 determines to add a CP of the extended CP length, which is greater than the normal CP length, to the wireless signal.

Accordingly, even if multiple propagation paths are generated by the dynamic control relay devices 4 in a high frequency band, by changing the CP length to the extended CP length, which is greater than the normal CP length, it is possible to reduce the influence of delay waves, and prevent performance deterioration, taking into consideration the overhead due to the CP length. Also, by using the normal CP length and the extended CP length in a switched manner based on whether or not the propagation paths use any dynamic control relay devices 4, it is possible to reduce the overhead due to the CP. The present embodiment is suitable for wireless communication of the 5th generation mobile communication system using a dynamic control relay device.

### Second Embodiment

The following will describe the wireless communication system 1 according to a second embodiment. This wireless communication system 1 differs from the above-described first embodiment in the CP length determination processing operation performed by the CP control unit 22 of the wireless base station device 2, and other configurations and operations are the same as those in the first embodiment. Therefore, only the difference from the first embodiment is described, and descriptions of the other features are omitted.

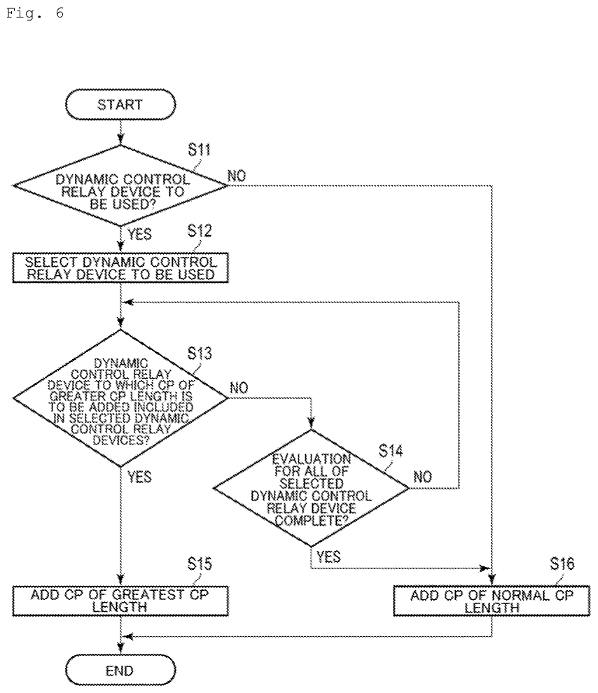

FIG. 6 is a flowchart illustrating an example of a CP length determination processing operation performed by the CP control unit 22 of the wireless base station device 2 according to the second embodiment. The CP control unit 22 stores a CP length setting condition (second CP length setting condition) for determining a CP length based on whether or not CP length information preliminarily allocated to selected dynamic control relay devices 4 includes the extended CP length. The CP control unit 22 allocates the CP of the normal CP length or the greatest CP length, which is greater than the normal CP length, to a wireless signal, based on whether or not the CP length information of the dynamic control relay devices 4 includes the extended CP length. If the wireless base station device 2 is constituted by a computer, the processor 31 can execute the processing operation in accordance with this flowchart by executing the communication control program, and can function as the CP control unit 22.

First, the CP control unit 22 determines whether or not the relay device control unit 5 has given a notification of determination to perform wireless transmission from the wireless base station device 2 to the wireless terminal device 3 of the communication target user using any dynamic control relay device 4 (step S11). The notification given from the relay device control unit 5 may be a notification indicating information as to whether or not any dynamic control relay device 4 is to be used, and information relating to selected one or more dynamic control relay devices 4, that is, information indicating which dynamic control relay device 4 is to be used.

If it is determined that the notification given from the relay device control unit 5 is an instruction to use any dynamic control relay device 4 (YES, in step S11), the CP control unit 22 selects one or more dynamic control relay devices 4 to be used, based on the CP length information of the dynamic control relay devices 4 included in the notification (step S12). Then, the CP control unit 22 references the CP length information preliminarily allocated to the selected dynamic control relay devices 4, and determines whether or not there is a dynamic control relay device 4 to which a CP of a CP length greater than the normal CP length is to be added in accordance with the CP length setting condition (step S13). In this determination, if it is determined based on the CP length information that there is no dynamic control relay device 4 to which a CP of a CP length greater than the normal CP length is to be added (NO, in step S14), the CP control unit 22 determines whether or not evaluation is complete for all of the dynamic control relay devices 4 selected in step S12 (step S14). If there is a dynamic control relay device 4 for which evaluation is not complete (NO, in step S14), the CP control unit 22 returns to the determination operation in step S13.

Also, in step S13, if it is determined based on the CP length information that there is a dynamic control relay device 4 to which a CP of a CP length greater than the normal CP length is to be added (YES, in step S13), the CP control unit 22 determines to add, to the wireless signal, a CP of the greatest CP length among the CP lengths added to the selected dynamic control relay devices 4. The CP addition unit 22 controls the CP addition unit 23 to add the CP of the greatest CP length to the wireless signal (step S15).

In contrast, in step S14, if it is determined that evaluation is complete for all of the selected dynamic control relay devices 4 (YES, in step S14), the CP control unit 22 determines to add a CP of the normal CP length to the wireless signal. The CP addition unit 22 controls the CP addition unit 23 to add the CP of the normal CP length to the wireless signal (step S16). Also, in step S11, if it is determined that the relay device control unit 5 has not given the determination to perform wireless transmission from the wireless base station device 2 to the wireless terminal device 3 of the target user using any dynamic control relay device 4 (NO, in step S11), the CP control unit 22 determines, in step S16, to add the CP of the normal CP length to the wireless signal. The CP addition unit 22 controls the CP addition unit 23 to add the CP of the normal CP length to the wireless signal.

Note that the preliminary allocation of CP lengths may be determined when the dynamic control relay devices 4 are installed, and can be stored in the CP control unit 22. Also, the preliminary allocation of CP lengths may also be stored in the relay device control unit 5, instead of the CP control unit 22, and the CP length information allocated to dynamic control relay devices 4 to be used may be transmitted from the relay device control unit 5 to the CP control unit 22, while being included in the above-described notification. Also, if a dynamic control relay device 4 includes a GPS sensor or a gyrosensor, the dynamic control relay device 4 may notify the relay device control unit 5 of the wireless base station device 2 of positional information obtained by the GPS sensor of the dynamic control relay device 4 or installation angle information obtained by the gyrosensor in a wired or wireless manner on a regular basis, and the relay device control unit 5 may determine an appropriate CP length and may perform update and saving.

As described above, when the relay device control unit 5 performs wireless transmission from the wireless base station device 2 to the wireless terminal device 3 using any dynamic control relay device 4, the CP lengths or the CP length information preliminarily allocated to the selected one or more dynamic control relay devices 4 are given to the CP control unit 22. The CP control unit 22 references the CP lengths or the CP length information of all of the selected dynamic control relay devices 4, and determines to add a CP of the greatest CP length among them.

As described above, in the second embodiment, the CP control unit 22 adds the CP of the greatest CP length among the CP lengths preliminarily allocated to the dynamic control relay devices. That is to say, when performing wireless transmission using a plurality of propagation paths via the dynamic control relay devices 4, the CP control unit 22 determines to add a CP of the greatest of the CP lengths of the selected dynamic control relay devices. By selecting a CP length according to a propagation path in this manner, it is possible to dynamically switch to a CP length with which the influence of delay waves is reduced. Accordingly, it is possible to prevent the use of an unduly long CP length and reduce the overhead due to the CP, compared to a case where a fixed CP length is used taking into consideration delay waves.

### Third Embodiment

The wireless communication system 1 according to a third embodiment differs from the above-described first embodiment in the CP length determination processing operation performed by the CP control unit 22 of the wireless base station device 2, and other configurations and operations are the same as those in the first embodiment. Therefore, only the difference from the first embodiment is described, and descriptions of the other features are omitted.

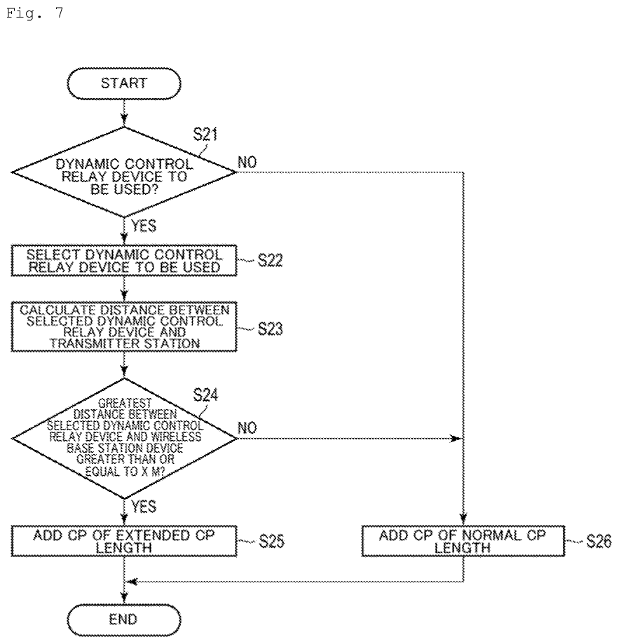

FIG. 7 is a flowchart illustrating an example of a CP length determination processing operation performed by the CP control unit 22 of the wireless base station device 3 according to the second embodiment. The CP control unit 22 stores a CP length setting condition (third CP length setting condition) for determining a CP length based on whether the greatest distance from among the distances between selected dynamic control relay devices 4 and the wireless base station device 2 is greater than or equal to a threshold. The CP control unit 22 allocates the CP of the normal CP length or the extended CP length, which is greater than that the normal CP, to a wireless signal, based on the calculated greatest distance. If the wireless base station device 2 is constituted by a computer, the processor 31 can execute the processing operation in accordance with this flowchart by executing the communication control program, and can function as the CP control unit 22.

First, the CP control unit 22 determines whether or not the relay device control unit 5 has given a notification of determination to perform wireless transmission from the wireless base station device 2 to the wireless terminal device 3 of the communication target user using any dynamic control relay device 4 (step S21). The notification given from the relay device control unit 5 may be a notification indicating information as to whether or not any dynamic control relay device 4 is to be used, and information relating to selected one or more dynamic control relay devices 4, that is, information indicating which dynamic control relay device 4 is to be used.

If it is determined that the notification given from the relay device control unit 5 is an instruction to use any dynamic control relay device 4 (YES, in step S21), the CP control unit 22 selects one or more dynamic control relay devices 4 to be used, based on the information of the dynamic control relay devices 4 included in the notification (step S22). Then, the CP control unit 22 calculates the distances between all of the selected dynamic control relay devices 4 and the wireless base station device 2, in accordance with the CP length setting condition (step S23). Note that instead of calculating the distances, distances that were calculated in advance may be referenced. Information relating to the calculated distances are stored in the relay device control unit 5 or the CP control unit 22, for example.

Furthermore, the CP control unit 22 determines whether the greatest distance of the distances between the selected dynamic control relay devices 4 and the wireless base station device 2 is greater than or equal to a predetermined threshold distance X m (step S24). Where X is any value, and may be calculated based on a propagation delay acceptable by the wireless system. Here, if it is determined that the greatest distance is greater than or equal to the predetermined threshold distance X m (YES, in step S24), there is a likelihood that the wireless terminal device 3 receives delay that exceeds the normal CP length. Therefore, the CP control unit 22 determines to add a CP of the extended CP length, which is greater than the normal CP length. The CP addition unit 22 controls the CP addition unit 23 to add the CP of the extended CP length to a wireless signal (step S25).

In contrast, in step S24, if it is determined that the greatest distance is not greater than or equal to the predetermined threshold distance X m (NO, in step S24), the CP control unit 22 determines to add a CP of the normal CP length to the wireless signal. The CP addition unit 22 controls the CP addition unit 23 to add the CP having the normal CP length to the wireless signal (step S26).

Also in step S21, if it is determined that the relay device control unit 5 has not given a notification of determination to perform wireless transmission from the wireless base station device 2 to the wireless terminal device 3 of the target user using any dynamic control relay device 4 (NO, in step S21), the CP control unit 22 determines, in step S26, to add the CP of the normal CP length to the wireless signal. The CP addition unit 22 controls the CP addition unit 23 to add the CP of the normal CP length to the wireless signal.

Note that if only dynamic control relay devices 4 located at a short distance from the wireless base station device 2 are used, the CP control unit 22 determines to add a CP of the normal CP length, since there is a low likelihood that the wireless terminal device 3 receives delay waves that exceeds the normal CP length.

Also, calculation of the distance between the wireless base station device 2 and each of the dynamic control relay devices 4 may be performed such that when the dynamic control relay device 4 is installed, the positional information is registered in the CP control unit 22, and the distance is calculated based on this positional information and positional information of the wireless base station device 2. Alternatively, by installing a GPS in each dynamic control relay device 4, the GPS information may be acquired via a line connecting the dynamic control relay device 4 and the relay device control unit as needed, and the distance may be calculated based thereon.

As described above, in the third embodiment, the CP control unit 22 determines the CP length based on the distances between the wireless base station device 2 and the dynamic control relay devices 4, and adds the CP of the determined CP length to a wireless signal. That is to say, if the greatest distance of the distances between the wireless base station device 2 and the plurality of dynamic control relay devices 4 is greater than or equal to a predetermined threshold distance X m, the CP control unit 22 determines the extended CP length, which is greater than the normal CP length, and adds the CP of the determined CP length to a wireless signal. By selecting a CP length according to a propagation path in this manner, it is possible to dynamically switch to a CP length with which the influence of delay waves is reduced (so that the ratio of the CP length to the OFDM symbol length is constant, for example). Accordingly, it is possible to prevent the use of an unduly long CP length and reduce the overhead due to the CP, compared to a case where a CP of a fixed CP length is used taking into consideration delay waves.

### Fourth Embodiment

The wireless communication system 1 according to a fourth embodiment differs from the first embodiment in the CP length determination processing operation performed by the CP control unit 22 of the wireless base station device 2, and other configurations and operations are the same as those in the first embodiment. Therefore, only the above-described difference from the first embodiment is described, and descriptions of the other features are omitted.

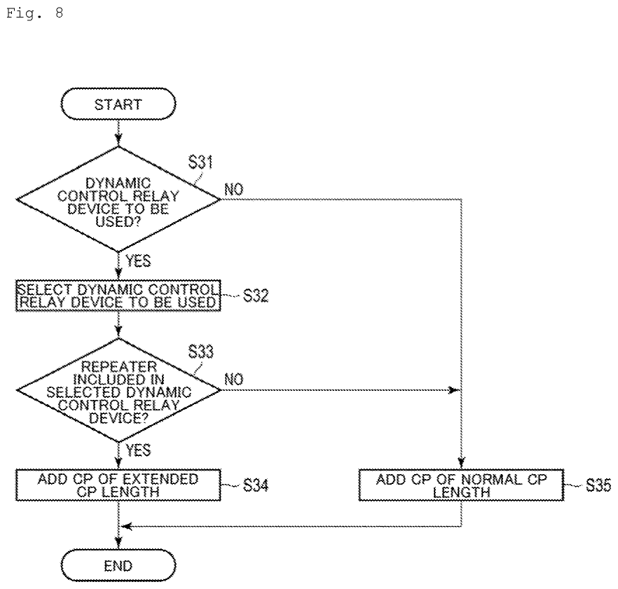

FIG. 8 is a flowchart illustrating an example of a CP length determination processing operation performed by the CP control unit 22 of the wireless base station device 2 according to the fourth embodiment. The CP control unit 22 stores a CP length setting condition (fourth CP length setting condition) for determining a CP length based on whether or not there is a repeater in the selected dynamic control relay devices 4. The CP control unit 22 allocates the CP of the normal CP length or the extended CP length, which is greater than that of the normal CP, to a wireless signal, based on whether or not there is a repeater (active device). If the wireless base station device 2 is constituted by a computer, the processor 31 can execute the processing operation in accordance with this flowchart by executing the communication control program, and can function as the CP control unit 22.

First, the CP control unit 22 determines whether or not the relay device control unit 5 has given a notification of determination to perform wireless transmission from the wireless base station device 2 to the wireless terminal device 3 of the target user using any dynamic control relay device 4 (step S31). The notification given from the relay device control unit 5 may be a notification indicating information as to whether or not any dynamic control relay device 4 is to be used, and information relating to selected one or more dynamic control relay devices 4, that is, information indicating which dynamic control relay device 4 is to be used.

If it is determined that the notification given from the relay device control unit 5 is an instruction to use any dynamic control relay device 4 (YES, in step S31), the CP control unit 22 selects the one or more dynamic control relay devices 4 that are to be used and are included in the notification from the relay device control unit 5 (step S32). Then, the CP control unit 22 determines whether or not a repeater is included in the selected dynamic control relay devices 4, in accordance with the CP length setting condition (step S33). In the determination, if it is determined that a repeater is included (YES, in step S33), the CP control unit 22 determines to add the extended CP whose length is greater than the normal CP length to a wireless signal. The CP addition unit 22 controls the CP addition unit 23 to add the extended CP to the wireless signal (step S34).

In contrast, in step S33, if it is determined that no repeater is included (NO, in step S33), the CP control unit 22 determines the CP of the normal CP length as the CP to be added to the wireless signal. The CP addition unit 22 controls the CP addition unit 23 to add the CP of the normal CP length to the wireless signal (step S35). Also, in step S31, if it is determined that the relay device control unit 5 has not given a notification of determination to perform wireless transmission from the wireless base station device 2 to the wireless terminal device 3 of the target user using any dynamic control relay device 4 (NO, in step S31), the CP control unit 22 determines to add a CP of the normal CP length to a wireless signal. The CP addition unit 22 controls the CP addition unit 23 to add the CP of the normal CP length to the wireless signal.

As described above, in the fourth embodiment, the CP control unit 22 determines the CP length based on the type of the dynamic control relay device 4 to be used. In a repeater, which is an active device, a processing delay due to amplification processing performed within the repeater is added, and thus delays occur more frequently than in a reflector, which is a passive device. Thus, if a repeater is included in the dynamic control relay devices 4 to be used, the CP control unit 22 determines to add the extended CP whose CP length is greater than the normal CP length. Also, if a repeater is used as a dynamic control relay device 4, it is possible to reduce the influence of delay waves resulting from a delay caused by amplification processing within the repeater.

### Fifth Embodiment

The wireless communication system 1 according to a fifth embodiment differs from the above-described first embodiment in the CP length determination processing operation performed by the CP control unit 22 of the wireless base station device 2, and other configurations and operations are the same as those in the first embodiment. Therefore, only the difference from the first embodiment is described, and descriptions of the other features are omitted.

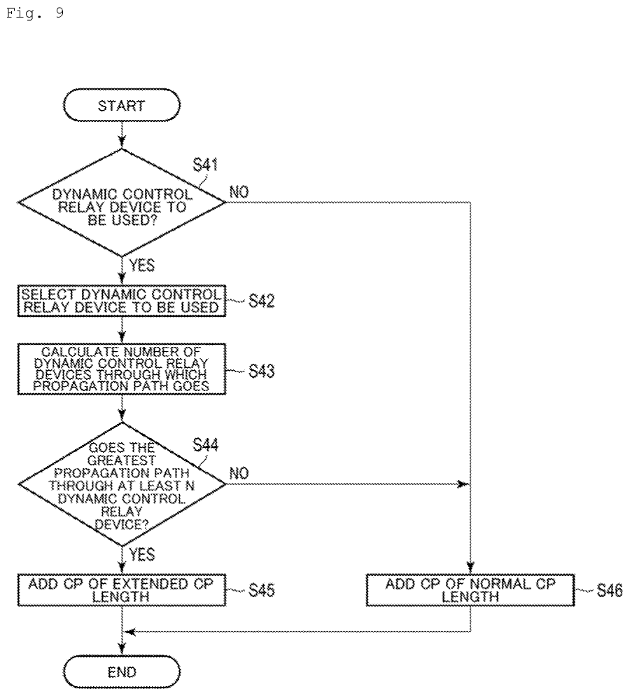

FIG. 9 is a flowchart illustrating an example of a CP length determination processing operation performed by the CP control unit 22 of the wireless base station device 2 according to the fifth embodiment. The CP control unit 22 stores a CP length setting condition (fourth CP length setting condition) for determining a CP length based on a threshold for the number of dynamic control relay devices 4 through which each propagation path goes, out of the selected dynamic control relay devices 4. The CP control unit 22 allocates the CP of the normal CP length or the extended CP length, which is greater than that of the normal CP, to a wireless signal, based on the number of dynamic control relay devices 4. If the wireless base station device 2 is constituted by a computer, the processor 31 can execute the processing operation in accordance with this flowchart by executing the communication control program, and can function as the CP control unit 22.

First, the CP control unit 22 determines whether or not the relay device control unit 5 has given a notification of determination to perform wireless transmission from the wireless base station device 2 to the wireless terminal device 3 of the target user using any dynamic control relay device 4 (step S41). The notification given from the relay device control unit 5 may be a notification indicating whether or not any dynamic control relay device 4 is to be used, and information relating to selected one or more dynamic control relay devices 4, that is, information indicating which dynamic control relay device 4 is to be used.

If it is determined that the notification given from the relay device control unit 5 is an instruction to use any dynamic control relay device 4 (YES, in step S41), the CP control unit 22 selects the one or more dynamic control relay devices 4 that are to be used and are included in the notification from the relay device control unit 5 (step S42).

Then, the CP control unit 22 calculates the number of dynamic control relay devices 4 that are interposed in each propagation path, that is, the number of dynamic control relay devices 4 through which each propagation path goes (step S43). Note here that the CP control unit 22 may reference the numbers of dynamic control relay devices that were calculated in advance and stored, instead of calculating the numbers.

Also, the CP control unit 22 determines whether or not the maximum number of the calculated numbers of dynamic control relay devices 4 is greater than or equal to a predetermined threshold number N, that is, whether or not the propagation path that uses the largest number of dynamic control relay devices 4 goes through at least N dynamic control relay devices 4 (step S44). Here, N is any value, and may be calculated based on a propagation delay acceptable by the wireless system. In the determination, if it is determined that the propagation path goes through N (threshold number) dynamic control relay devices 4 or more (YES, in step S44), the CP control unit 22 determines to add the extended CP length, which is greater than the normal CP length, to a wireless signal. The CP addition unit 22 controls the CP addition unit 23 to add the extended CP to the wireless signal (step S45).

In contrast, in step S44, if it is determined that the propagation path that uses the largest number of dynamic control relay devices 4 does not go through at least N dynamic control relay devices 4 (NO, in step S44), the CP control unit 22 determines to add a CP of the normal CP length to the wireless signal. The CP addition unit 22 controls the CP addition unit 23 to add the CP of the normal CP length to the wireless signal (step S46). Also, in step S41, if it is determined that the relay device control unit 5 has not given a notification of determination to perform wireless transmission from the wireless base station device 2 to the wireless terminal device 3 of the target user using any dynamic control relay device 4 (NO, in step S41), the CP control unit 22 determines to add a CP of the normal CP length to the wireless signal. Based on this determination, the CP addition unit 22 controls the CP addition unit 23 to add the CP of the normal CP length to the wireless signal.

Thus, a propagation path is longer the larger the number of dynamic control relay devices 4 to perform relay, and thus there is a likelihood that delay waves occur in the propagation path. Accordingly, if the number of dynamic control relay devices 4 through which a propagation path goes is a given number (for example, N) or more, the CP control unit 22 determines to add a CP of the extended CP length, which is greater than the normal CP length, and if the number is less than the given number, the CP control unit 22 determines to add a CP of the normal CP length.

As described above, in the fifth embodiment, the CP control unit 22 determines a CP length based on the number of dynamic control relay devices 4 to be passed through. That is to say, the CP control unit 22 estimates a route for each of a plurality of propagation paths that use selected dynamic control relay devices 4, and if the largest route length is greater than or equal to a predetermined threshold route length, that is, if the number of dynamic control relay devices 4 through which the propagation path goes is greater than or equal to the threshold number N, the CP control unit 22 determines to add a CP of the extended CP length, which is greater than the normal CP length, to a wireless signal. With this, it is possible to reduce the influence of delay waves caused by using the dynamic control relay devices 4 in this wireless communication system 1.

### Sixth Embodiment

The wireless communication system 1 according to a sixth embodiment differs from the above-described first embodiment in the CP length determination processing operation performed by the CP control unit 22 of the wireless base station device 2, and other configurations and operations are the same as those in the first embodiment. Therefore, only the difference from the first embodiment is described, and descriptions of the other features are omitted.

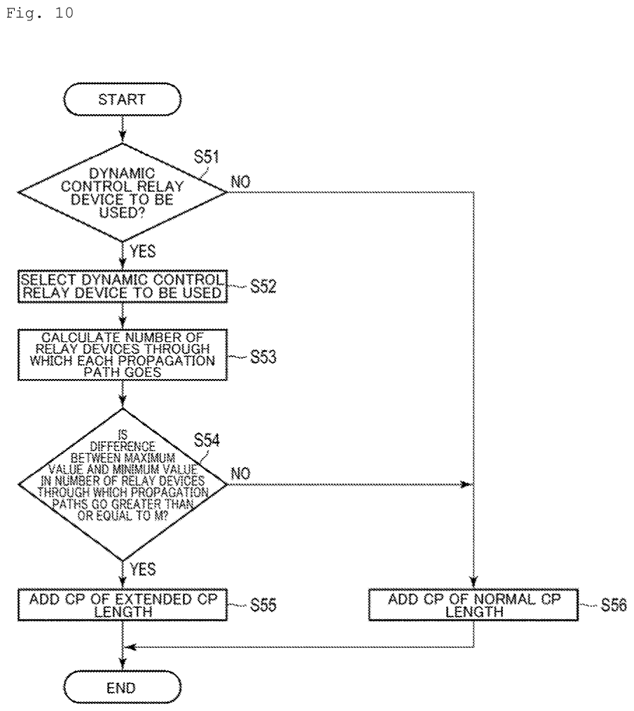

FIG. 10 is a flowchart illustrating an example of a CP length determination processing operation performed by the CP control unit 22 of the wireless base station device 2 according to the sixth embodiment. The CP control unit 22 stores a CP length setting condition (fifth CP length setting condition) for determining a CP length based on a threshold for a difference between the maximum value and the minimum value in the number of relay devices of the dynamic control relay devices 4 through which propagation paths go, out of the selected dynamic control relay devices 4. The CP control unit 22 allocates a CP of the normal CP length or the extended CP length, which is greater than that of the normal CP, to a wireless signal, based on the threshold. If the wireless base station device 2 is constituted by a computer, the processor 31 can execute the processing operation in accordance with this flowchart by executing the communication control program, and can function as the CP control unit 22.

First, the CP control unit 22 determines whether or not the relay device control unit 5 has given a notification of determination to perform wireless transmission from the wireless base station device 2 to the wireless terminal device 3 of the target user using any dynamic control relay device 4 (step S51). The notification given from the relay device control unit 5 may be a notification indicating whether or not any dynamic control relay device 4 is to be used, and information relating to selected one or more dynamic control relay devices 4, that is, information indicating which dynamic control relay device 4 is to be used.

If it is determined that the notification given from the relay device control unit 5 is an instruction to use any dynamic control relay device 4 (YES, in step S51), the CP control unit 22 selects the one or more dynamic control relay devices 4 that are to be used and are included in the notification from the relay device control unit 5 (step S52). Then, the CP control unit 22 calculates the number of dynamic control relay devices 4 that are interposed in each propagation path, that is, the number of dynamic control relay devices 4 through which each propagation path goes, in accordance with the CP length setting condition (step S53). Note here that the CP control unit 22 may reference the numbers of dynamic control relay devices that were calculated in advance and stored, instead of calculating the numbers.

Also, the CP control unit 22 compares the maximum value and the minimum value of the calculated numbers of dynamic control relay devices 4, and determines whether the difference thereof is a predetermined number M or more (step S54). Here, M is any value, and may be calculated based on a propagation delay acceptable by the wireless system. In the determination, if it is determined that a difference between the maximum value and the minimum value of the numbers of dynamic control relay devices 4 through which the respective propagation paths go is greater than or equal to M (YES, in step S54), the CP control unit 22 determines to add the extended CP length, which is greater than the normal CP length. The CP addition unit 22 controls the CP addition unit 23 to add the extended CP to a wireless signal (step S55).

In contrast, in step S54, if it is determined that a difference between the maximum value and the minimum value of the numbers of dynamic control relay devices 4 through which the respective propagation paths go is not greater than or equal to M (NO, in step S54), the CP control unit 22 determines to add a CP of the normal CP length to the wireless signal. The CP addition unit 22 controls the CP addition unit 23 to add the CP of the normal CP length to the wireless signal (step S56).

Also, in step S51, if it is determined that the relay device control unit 5 has not given a notification of determination to perform wireless transmission from the wireless base station device 2 to the wireless terminal device 3 of the target user using any dynamic control relay device 4 (NO, in step S51), the CP control unit 22 determines to add a CP of the normal CP length to the wireless signal. Based on this determination, the CP addition unit 22 controls the CP addition unit 23 to add the CP of the normal CP length to the wireless signal.

A propagation path is longer the larger the number of dynamic control relay devices 4 to perform relay, and thus there is a likelihood that delay waves occur in the propagation path. On the other hand, even when the number of dynamic control relay devices 4 to perform relay is large, there may be a case where no delay wave is received if all of the propagation paths include the same number of dynamic control relay devices 4. In this case, if a CP length is set only based on the number of dynamic control relay devices 4, unnecessary overhead may be caused. Accordingly, if a difference between the maximum value and the minimum value of the numbers of dynamic control relay devices 4 through which the respective propagation paths go is a given number or more, the CP control unit 22 sets a CP length that is smaller than in a normal case, and otherwise sets the normal CP length.

As described above, in the sixth embodiment, the CP control unit 22 determines a CP length based on a difference between the maximum value and the minimum value of the numbers of dynamic control relay devices 4 through which the respective propagation path go. That is to say, the CP control unit 22 estimates a route for each of a plurality of propagation paths that use selected dynamic control relay devices 4, and if a difference between the maximum length and the minimum length of the routes is greater than or equal to a predetermined threshold length, that is, if a difference between the maximum number and the minimum number of dynamic control relay devices 4 through which the propagation paths go is greater than or equal to the threshold number M, the CP control unit 22 determines to add a CP of the extended CP length, which is greater than the normal CP length, to a wireless signal. Accordingly, it is possible to prevent the use of different CP lengths more than necessary and reduce unnecessary overhead.

The CP length determination processing operations that have been described as the second to sixth embodiments may be used alone, or a plurality of embodiments may be used in combination.

Also, the methods described with reference to the embodiments can be stored, as a program (software means) that can cause a computing machinery (computer) to execute it, in a recording medium such as a magnetic disk (such as a floppy (registered trademark) disk or a hard disk), an optical disk (such as CD-ROM, DVD, or MO), or a semiconductor memory (such as a ROM, RAM, or flash memory), or can be transmitted and distributed by a communication medium. Note that the program to be stored in the medium also includes a setting program that configures a software means (including not only an execution program but also a table and a data structure) for causing the computing machinery to execute the program within the computing machinery. The computing machinery that realizes this device reads the program recorded in the recording medium, or configure the software means using the setting program in certain instances, and executes the above-described processing when the software means controls the operations. Note that the recording medium used in the present specification is not limited to being used for distribution, but includes a storage medium such as a magnetic disk or a semiconductor memory that is provided inside the computing machinery or in a device connected via a network. With this, the functional units of the wireless base station device of the present invention except for the RF antenna unit can also be realized by a computer and a program, and can be provided via a network.

In short, the present invention is not limited to the above-described embodiments, and in the implementation stage, various modifications are possible without departing from the spirit of the invention. Also, the configurations described in the embodiments above may be implemented in suitable possible combinations, and in such a case, combined effects can be realized. Furthermore, the above-described embodiments include inventions in various stages, and various inventions are extracted through appropriate combinations of a plurality of disclosed constituent elements.

### REFERENCE SIGNS LIST

1 Wireless communication system
2 Wireless base station device
3 Wireless terminal device
4, 4a, 4b, 4c, 4d Dynamic control relay device
5 Relay device control unit
6 Wireless communicator
21, 51 Signal processing unit
22, 52 CP control unit
23, 53 CP addition unit
24, 54 CP removal unit
25, 55 Digital/analog converter
26, 56 Analog/digital converter
27, 57 RF antenna unit

### 28, 58 Antenna

### 31 Processor

32 Program memory
33 Data memory

### 34 Storage

35 Input/output interface
36 Communication interface
37 Communication unit

### 38 Bus

39 Input unit
40 Display unit

### 41 Antenna

1. A wireless communication system comprising:
a wireless base station device that includes a control unit for determining a cyclic prefix length, and is configured to perform wireless communication of an orthogonal frequency division multiplexing (OFDM) method;
a plurality of dynamic control relay devices for which a reradiation direction of incoming waves is dynamically controllable by the wireless base station device; and
a wireless terminal device configured to perform wireless communication with the wireless base station device using a plurality of propagation paths that go through or do not go through the dynamic control relay devices,
wherein if the wireless communication is performed between the wireless base station device and the wireless terminal device using the plurality of propagation paths going through the dynamic control relay devices, the control unit determines a second cyclic prefix length that is greater than a preliminarily allocated first cyclic prefix length if a predetermined setting condition that relates to wireless communication is satisfied.

2. The wireless communication system according to claim 1,
wherein the wireless base station device selects a dynamic control relay device to be used from among the plurality of dynamic control relay devices based on the wireless terminal device,
as the setting condition, information including cyclic prefix lengths respectively associated with the plurality of dynamic control relay devices is set in the control unit, and
if a cyclic prefix length that is greater than the first cyclic prefix length is set for the selected dynamic control relay device, the control unit determines the second cyclic prefix length as the cyclic prefix length based on the setting condition.

3. The wireless communication system according to claim 1,
wherein the wireless base station device selects dynamic control relay devices to be used from among the plurality of dynamic control relay devices based on the wireless terminal device, and estimates respective routes of the plurality of propagation paths going through the plurality of selected dynamic control relay devices,
as the setting condition, a distance of a propagation path is set in the control unit, and
if the greatest distance of distances of the propagation paths from the wireless base station device to the plurality of selected dynamic control relay devices is greater than a preset distance, the control unit determines the second cyclic prefix length, which is greater than the first cyclic prefix length, based on the setting condition.

4. The wireless communication system according to claim 1,
wherein the wireless base station device selects dynamic control relay devices to be used from among the plurality of dynamic control relay devices based on the wireless terminal device,
as the setting condition, whether or not there is an active device is set in the control unit, and
if an active device is included in the selected dynamic control relay devices, the control unit determines the second cyclic prefix length, which is greater than the first cyclic prefix length, based on the setting condition.

5. The wireless communication system according to claim 1,
wherein the wireless base station device selects dynamic control relay devices to be used from among the plurality of dynamic control relay devices based on the wireless terminal device, and estimates respective routes of the plurality of propagation paths going through the plurality of selected dynamic control relay devices,
as the setting condition, the number of dynamic control relay devices that perform relay is set in the control unit, and
if the number of the selected dynamic control relay devices that perform relay in the estimated routes is greater than a preset number of dynamic control relay devices that perform relay, the control unit determines the second cyclic prefix length, which is greater than the first cyclic prefix length, based on the setting condition.

6. The wireless communication system according to claim 1,
wherein the wireless base station device selects dynamic control relay devices to be used from among the plurality of dynamic control relay devices based on the wireless terminal device, and estimates respective routes of the plurality of propagation paths going through the plurality of selected dynamic control relay devices,
as the setting condition, a difference between the maximum length and the minimum length of the routes is set in the control unit, and
if the difference between the maximum length and the minimum length of the estimated routes is greater than or equal to a predetermined threshold length, the control unit determines the second cyclic prefix length, which is greater than the first cyclic prefix length, based on the setting condition.

7. A wireless control method that is performed in a wireless communication system that includes: a wireless base station device including a control unit for determining a cyclic prefix length; and a plurality of dynamic control relay devices for which a reradiation direction of incoming waves is dynamically controllable, the wireless base station device being configured to perform wireless communication of an orthogonal frequency division multiplexing (OFDM) method with a wireless terminal device using a plurality of propagation paths going through the dynamic control relay devices, the method comprising the steps of:
selecting, in the wireless base station device, dynamic control relay devices to be used in the wireless communication using the plurality of propagation paths, from among the plurality of dynamic control relay devices based on the wireless terminal device to be subjected to the wireless communication, and
adding, in the wireless base station device, a cyclic prefix of a second cyclic prefix length that is greater than a preliminarily allocated and normally used first cyclic prefix length, to a wireless signal, the second cyclic prefix length serving as a cyclic prefix length to be used in the wireless communication of the OFDM method using the plurality of propagation paths going through the dynamic control relay devices.

8. A wireless base station device provided in a wireless communication system that includes: a wireless base station device; and a plurality of dynamic control relay devices for which a reradiation direction of incoming waves is dynamically controllable, the wireless base station device being configured to perform wireless communication of an orthogonal frequency division multiplexing (OFDM) method with a wireless terminal device using a plurality of propagation paths going through the dynamic control relay devices, the wireless base station device comprising:
a relay device control unit configured to select dynamic control relay device to be used in the wireless communication using the plurality of propagation paths, from among the plurality of dynamic control relay devices, based on the wireless terminal device to be subjected to the wireless communication; and
a control unit configured to determine, if the wireless communication is performed between the wireless base station device and the wireless terminal device using the plurality of propagation paths going through the dynamic control relay devices, a second cyclic prefix length that is greater than a preliminarily allocated first cyclic prefix length, as a cyclic prefix length to be used in the wireless communication of the OFDM method.
